(19) United States
(12) Patent Application Publication
(10) Pub. No.: US 2016/0253597 A1
(43) Pub. Date: Sep. 1, 2016

(54) CONTENT-AWARE DOMAIN ADAPTATION FOR CROSS-DOMAIN CLASSIFICATION

(71) Applicant: Xerox Corporation, Norwalk, CT (US)

(72) Inventors: Himanshu Sharad Bhatt, New Delhi (IN); Deepali Semwal, Dehradun (IN); Shourya Roy, Bangalore (IN)

(21) Appl. No.: 14/633,550

(22) Filed: Feb. 27, 2015

(51) Int. Cl. G06N 99/00

(52) U.S. Cl. CPC G06N 99/005

(57) ABSTRACT

An adaptation method includes using a first classifier trained on projected representations of labeled objects from a first domain to predict pseudo-labels for unlabeled objects in a second domain, based on their projected representations. A classifier ensemble is iteratively learned. The ensemble includes a weighted combination of the first classifier and a second classifier. This includes training the second classifier on the original representations of the unlabeled objects for which a confidence for respective pseudo-labels exceeds a threshold. A classifier ensemble is constructed as a weighted combination of the first classifier and the second classifier. Pseudo-labels are predicted for the remaining original representations of the unlabeled objects with the classifier ensemble and weights of the first and second classifiers in the classifier ensemble are adjusted. As the iterations proceed, the unlabeled objects progressively receive pseudo-labels which can be used for retraining the second classifier.

### BACKGROUND

The exemplary embodiment relates to classification and finds particular application in connection with domain adaptation for cross-domain classification, such as for sentiment and topic categorization.

Machine learning (ML)-based techniques are widely used for processing large amounts of data useful in providing business insights. For example, processing social media posts and opinion website reviews can provide businesses with useful information as to how customers view their products and services. Many ML-based automated processes involve categorization and classification of the user-generated content in a supervised learning fashion. In supervised learning, algorithms are trained to learn categorization based on examples which have been labeled with pre-defined categories by analysts. Using these examples, a ML-based algorithm is trained and expected to perform automatic classification on new examples. The performance of these algorithms is typically a function of the quantity and quality of the available training data.

Such ML-based techniques assume that the training and test data follow the same distribution. In practice, however, this assumption often does not hold true and the performance is reduced when the data distribution in the test (target) domain differs from that in the training (source) domain (known as cross-domain classification). For example, a business may include several business units and wish to reuse classifiers learned on the data acquired for one business unit on the data acquired for another, but finds that the performance in the new domain is not very reliable.

To address this, the algorithm may be re-trained from scratch on new labeled data available in the test domain. However, this approach has several problems. First, re-training a classifier can be costly and time consuming. Second, there may be a limited amount of labeled training data available for the test domain, whereas considerable labeled data is available from a related but different domain or domains. It is thus desirable that ML-based techniques are able to reuse the knowledge and adapt from one domain to another. Specifically, it would be advantageous for algorithms trained on labeled training data from one domain to be able to perform the same task efficiently in a different but related domain.

Domain adaptation has been studied extensively for a number of classification tasks. It attempts to adapt a model to a target domain using the knowledge gained in the related source domain with minimum (or no) supervision. This minimizes the need for labeled training data from the test domain and learning models from scratch each time for different test data. Approaches proposed for cross-domain sentiment classification generally focus on learning a shared low dimensional representation of features that can be generalized across different domains. One such approach is known as structural correspondence learning (SCL). See Blitzer, et al., “Domain adaptation with structural correspondence learning,” Proc. Conf. on Empirical Methods in Natural Language Processing (EMNLP), pp. 120-128 (2006), hereinafter, “Blitzer 2006.” The shared representation is based on co-occurrence statistics and has shown significant improvements over shift-unaware models as it can leverage the correspondences between features across the two domains. However, such a representation does not consider that each domain may have specific features which are highly discriminative in that domain.

Domain adaptation-based approaches often focus on what to transfer and when to transfer it. See S. J. Pan, et al., “A survey on transfer learning,” IEEE Trans. on Knowledge and Data Engineering, vol. 22, no. 10, pp. 1345-1359, (2010). However, the question of how much knowledge to transfer is rarely discussed. Domain adaptation techniques are generally restricted in performance based on the similarity between the source and target domains. If two domains are largely similar, the knowledge learned in source domain can be readily adapted to the target domain. Some approaches have therefore used similarity as a measure to select the most appropriate source domain from multiple available source domains. See Blitzer, et al., “Biographies, bollywood, boomboxes and blenders: Domain adaptation for sentiment classification,” Proc. Assoc. for Computational Linguistics, pp. 187-205 (2007), hereinafter, “Blitzer 2007.” However, this method cannot make use the similarity if there is only one source domain.

There remains a need for an improved system and method for cross-domain classification in cases where there is little or no target domain training data.

### INCORPORATION BY REFERENCE

The following references, the disclosures of which are incorporated herein by reference in their entireties by reference, are mentioned:

U.S. application Ser. No. 14/477,215, filed Sep. 4, 2014, entitled DOMAIN ADAPTATION FOR IMAGE CLASSIFICATION WITH CLASS PRIORS, by Boris Chidlovskii and Gabriela Csurka discloses a labeling system with a boost classifier trained to classify an image belonging to a target domain and represented by a feature vector. Labeled feature vectors representing training images for both the target domain and a set of source domains are provided for training. Training involves generating base classifiers and base classifier weights of the boost classifier in an iterative process. At one of the iterations, a set of sub-iterations is performed, in which a candidate base classifier is trained on a training set combining the target domain training set and the source domain training set and the candidate base classifier with lowest error for the target domain training set is selected. Given a feature vector representing the image to be labeled, a label is generated for the image using the learned weights and selected candidate base classifiers.

U.S. application Ser. No. 14/504,837, filed Oct. 2, 2014, entitled SYSTEM FOR DOMAIN ADAPTATION WITH A DOMAIN-SPECIFIC CLASS MEANS CLASSIFIER, by Gabriela Csurka, et al. discloses a classifier model having been learned with training samples from the target domain and training samples from a source domain different from the target domain. The classifier model models a respective class as a mixture of components, including source and target domains, where each component is a function of a distance between a test sample and a domain-specific class representation which is derived from the training samples of the respective domain that are labeled with the class, each of the components in the mixture being weighted by a respective mixture weight.

U.S. Pub. No. 20110040711, published Feb. 17, 2011, entitled TRAINING A CLASSIFIER BY DIMENSION-WISE EMBEDDING OF TRAINING DATA, by Florent C. Perronnin, et al., discloses methods for representing and classifying images in which image representations are embedded in a higher dimensional space.

### BRIEF DESCRIPTION

In accordance with one aspect of the exemplary embodiment, an adaptation method includes providing a first classifier trained on projected representations of objects from a first domain and respective labels. The projected representations have been generated by projecting original representations of the objects in the first domain into a shared feature space with a learned transformation. A pool of original representations of unlabeled objects in a second domain is provided. The original representations of the unlabeled objects are projected with the learned transformation. Pseudo-labels for the projected representations of the unlabeled objects are predicted with the first classifier. Each of the predicted pseudo-labels is associated with a respective confidence. The method further includes iteratively learning a classifier ensemble that includes a weighted combination of the first classifier and a second classifier. The iterative learning includes training the second classifier on the original representations of the unlabeled objects for which the confidence for respective pseudo-labels exceeds a threshold, constructing a classifier ensemble as a weighted combination of the first classifier and the second classifier, predicting pseudo-labels for remaining unlabeled objects with the classifier ensemble based on their original representations, adjusting weights of the first and second classifiers in the classifier ensemble as a function of a learning rate, and repeating the training, constructing, predicting, and adjusting one or more times.

At least one of the predicting of pseudo-labels and iteratively learning the classifier ensemble may be performed with a processor.

In accordance with another aspect of the exemplary embodiment, an adaptation system includes memory which stores a learned transformation, a first classifier that has been trained on projected representations of objects from a first domain and respective labels, the projected representations having been generated by projecting original representations of the objects in the first domain with the learned transformation. Optionally, a representation generator generates original representations of unlabeled objects in a second domain. A transformation component projects the original representations of the unlabeled objects with the learned transformation. A prediction component predicts pseudo-labels for unlabeled objects in a second domain with the first classifier, based on the projected representations of the unlabeled objects. An ensemble learning component iteratively learns a classifier ensemble comprising a weighted combination of the first classifier and a second classifier. The learning includes training the second classifier on the original representations of the unlabeled objects for which a confidence for the respective pseudo-labels exceeds a threshold confidence, constructing a classifier ensemble as a weighted combination of the first classifier and the second classifier, predicting pseudo-labels for remaining unlabeled objects with the classifier ensemble based on their original representations, adjusting weights of the first and second classifiers in the classifier ensemble as a function of a learning rate, and repeating the training, constructing, predicting, and adjusting. A processor implements the transformation component, prediction component, and ensemble learning component.

In accordance with another aspect of the exemplary embodiment, an adaptation method includes learning a transformation based on features extracted from objects in first and second domains. A similarity is computed between the first and second domains. Original representations of labeled objects in the first domain and unlabeled objects in the second domain are projected with the learned projection. A first classifier is trained on the projected representations of the objects from the first domain and respective labels. Pseudo-labels for the projected representations of the unlabeled objects are predicted with the first classifier. A classifier ensemble comprising a weighted combination of the first classifier and a second classifier is iteratively learned. The learning includes training the second classifier on the original representations of those of the unlabeled objects and respective pseudo-labels for which a confidence for the respective pseudo-labels exceeds a threshold confidence, constructing a classifier ensemble as a weighted combination of the first classifier and the second classifier, predicting pseudo-labels for the original representations of remaining unlabeled objects with the classifier ensemble, adjusting weights of the first and second classifiers in the classifier ensemble as a function of the computed similarity, and repeating the training, constructing, predicting, and adjusting.

At least one of the learning of the transformation, computing of the similarity, projecting of the original representations, training of the first classifier, predicting of the pseudo-labels, and iteratively learning the classifier ensemble may be performed with a processor.

### BRIEF DESCRIPTION OF THE DRAWINGS

FIG. 1 is a functional block diagram of a cross-domain adaptation system in accordance with one aspect of the exemplary embodiment;

FIG. 2 is a flow chart illustrating a method for cross-domain adaptation in accordance with another aspect of the exemplary embodiment;

FIG. 3 is a flow chart illustrating an iterative learning process in the method of FIG. 2;

FIG. 4 is an overview of the exemplary system and method;

FIG. 5 graphically illustrates results comparing the performance of the exemplary method with other techniques, using Domain D (DVDs) as the target domain;

FIG. 6 graphically illustrates results comparing the performance of the exemplary method with other techniques, using Domain B (books) as the target domain;

FIG. 7 graphically illustrates results comparing the performance of the exemplary method with other techniques, using Domain E (electronics) as the target domain; and

FIG. 8 graphically illustrates results comparing the performance of the exemplary method with other techniques, using Domain K (kitchen appliances) as the target domain.

### DETAILED DESCRIPTION

The exemplary embodiment relates to a system and method for adapting a classifier that has been trained on representations of labeled objects in a first (source) domain to the classification of unlabeled objects in a second (target) domain.

The objects to be classified in the target domain can be text documents, images, or any other object from which features can be extracted to generate a multidimensional feature-based representation of the object.

The system and method assumes that there are no labeled objects in the target domain. However, the method is also applicable to cases where some of the target domain objects are labeled.

In the exemplary embodiment, a classifier ensemble is generated, which is a weighted combination of first and second classifiers. The first classifier is trained on representations of source domain objects and their corresponding labels. The representation of each source domain object is a transformed co-occurrence-based feature representation that is shared across the first and second domains. The second classifier is iteratively trained on representations of the target domain objects and corresponding pseudo-labels. The second classifier training iteratively learns domain-specific features that can be used to adapt the second classifier to the target domain for enhanced classification performance. During the iterative training, the first and second classifier weights are progressively updated as a function of a learning rate. Once the second classifier has been learned, the classifier ensemble can be used for labeling new objects in the target domain.

Further, in some embodiments, the exemplary method facilitates this adaptation in a content-aware manner by seamlessly unifying the similarity between the two domains in the adaptation setting. This is also useful in practical scenarios where there are multiple candidate source domains to learn from and method is able to identify the best source domain from which to learn.

The exemplary system and method can efficiently adapt classifier models trained on one domain to perform well for classification on different domains, without requiring any labeled data from the target domain. The system and method provide the capability to sustain the performance in the target domain as well as yielding significant benefits in terms of reducing the need for expensive and computational human annotations.

Before describing the present system and method, a description of the Structural Correspondence Learning (SCL) method will be provided. In the SCL method for cross-domain sentiment classification of Blitzer 2006, for example, a shared low dimensional representation of features that can be generalized across different domains is learned. SCL aims to learn the co-occurrence between features from two domains which may express the same polarity (e.g., a positive opinion or a negative opinion) in the source and target domains. The method starts with identifying pivot features that occur frequently in both domains. Then method models a correlation between these pivot features and the other features in a set of features by training linear predictors (pivot predictors) to predict the presence of the pivot features in unlabeled data. Each pivot predictor is characterized by a weight vector w, and all pivot predictors are combined to form a matrix Q. The +ve entries in the matrix represents the non-pivot features which are highly correlated with the pivot features.

For example, the top Eigenvectors of the matrix Q are computed. These represent the principal predictors for the weight space. These principal predictors efficiently discriminate among positive and negative features (e.g., words in the case of documents) in both domains. The features from both the domains are then projected into this principal predictor space to obtain the shared co-occurrence-based representation. A classifier trained on the original feature representation concatenated with this shared co-occurrence based representation performs fairly well on both the domains.

The shared representation based on the co-occurrence statistics of the SCL method has shown significant improvements over baseline (shift-unaware) models as it can leverage the correspondences between features across two domains. However, such a representation ignores the observation that each domain tends to have specific features which are highly discriminative in that domain. Such domain-specific features are not captured by existing methods, such as SCL, as the existing methods exploit only the commonality between domains and not the differences between them. In the present system and method, the aim is to include the domain-specific features from the target domain to enhance the performance over that of the shared co-occurrence-based feature representation.

Another problem with the method of Blitzer 2006 is that if the source and target domains are largely dissimilar, the method can lead to negative transfer, which degrades the performance in the domain of interest. Some approaches (Blitzer 2007) have used similarity as a measure to select the most appropriate source domain from multiple available source domains. In the present method, the similarity between the two domains is integrated within the domain adaptation settings, rather than simply being a domain-selection criterion.

### Content-Aware Domain Adaptation

The exemplary system and method, referred to herein as Content-Aware Domain Adaptation (CADA), builds on existing methods to learn domain-specific features. The method starts with a feature co-occurrence based transformed representation, such as that produced by the SCL method. The method improves the performance of the cross-domain classification task by iteratively learning domain-specific features from unlabeled target domain data and training a classifier on these features in a semi-supervised manner. The exemplary method also incorporates a measure of similarity between the two domains in the adaptation setting to facilitate a content-aware transfer. An ensemble-based iterative semi-supervised approach is employed to transfer the knowledge from the source domain to the target domain in proportion to their similarity.

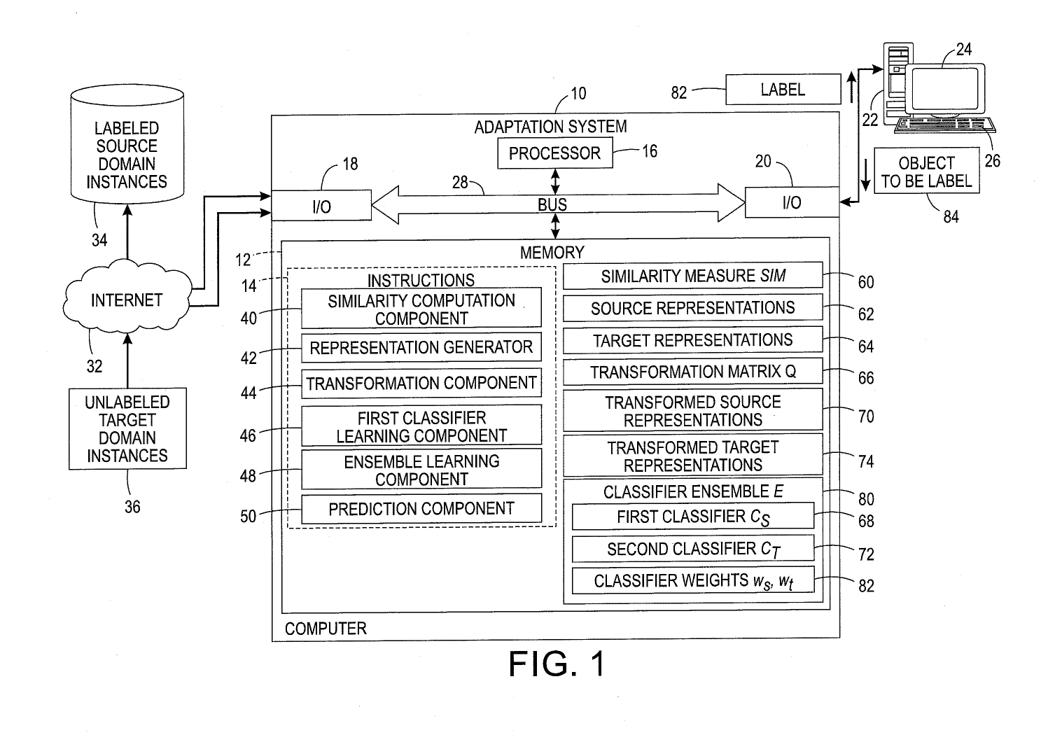

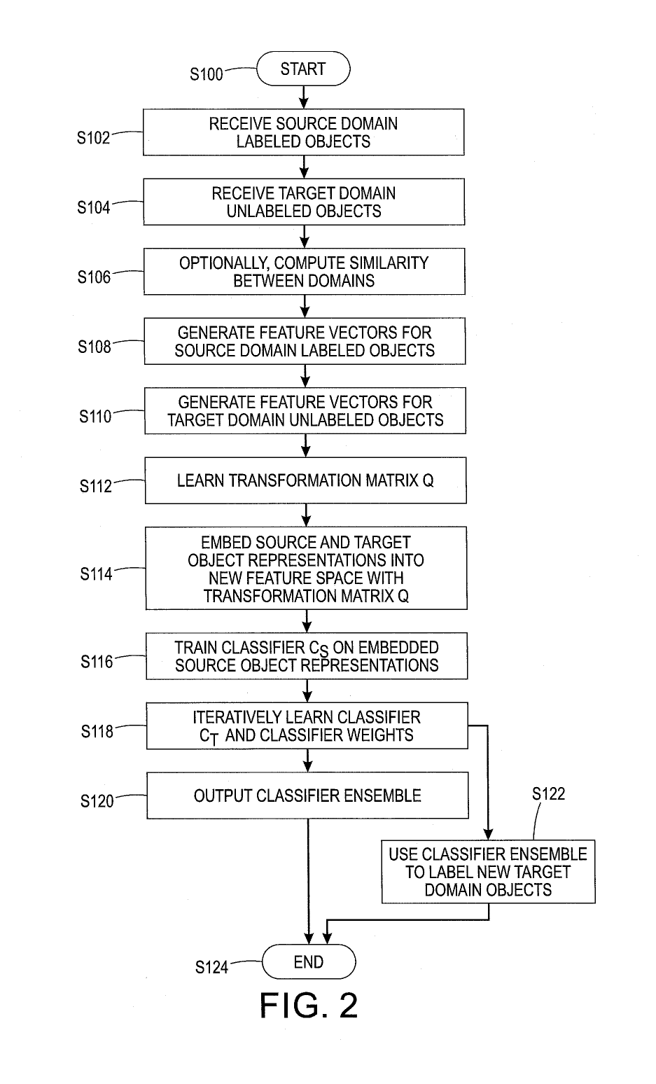

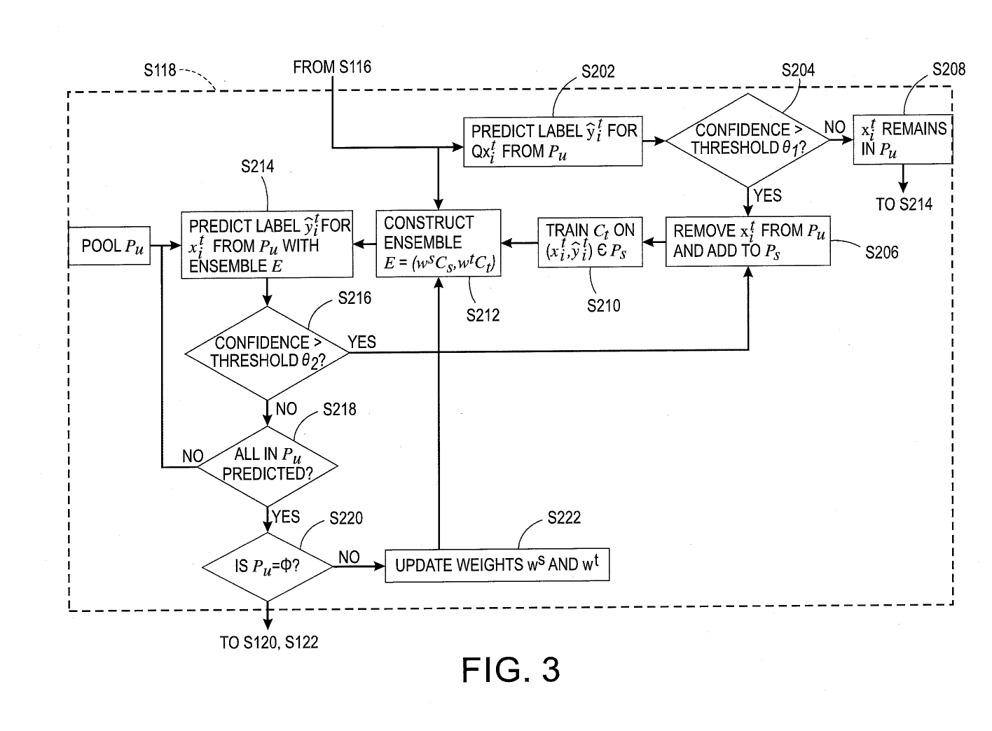

FIG. 1 illustrates a functional block diagram of a computer-implemented system 10 for content-aware cross-domain adaptation (CADA) of a classifier. The illustrated computer system 10 includes memory 12 which stores instructions 14 for performing the method illustrated in FIGS. 2 and 3 and a processor device 16 in communication with the memory for executing the instructions. The system 10 also includes one or more input/output (I/O) devices, such as a network interface 18 and a local input/output interface 20. The I/O interface 20 may communicate with a user interface device 22 which includes one or more of a display device 24, for displaying information to users, speakers, and a user input device 26, such as a keyboard or touch or writable screen, and/or a cursor control device, such as mouse, trackball, or the like, for inputting text and for communicating user input information and command selections to the processor device 16. The various hardware components 12, 16, 18, 20 of the system 10 may be all connected by a data/control bus 28.

The computer system 10 may include one or more computing devices 30, such as a desktop, laptop, tablet, or palmtop computer, portable digital assistant (PDA), server computer, cellular telephone, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores processed data as well as the instructions for performing the exemplary method.

The network interface 18 allows the computer to communicate with other devices via a link 32, such as a computer network, such as a local area network (LAN) or wide area network (WAN), or the internet, and may comprise a modulator/demodulator (MODEM) a router, a cable, and and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The system 10 has access to a collection 34 of labeled objects (instances) in a first (source) domain and a set 36 of unlabeled objects in a target domain (or in some embodiments, to feature-based representations of these objects), which may be stored in local memory 12 and/or in accessible, remote memory. In general, the collection 34 includes a large number of manually-labeled objects, such as at least 500 or at least 1000 objects, while the set 36 of unlabeled objects may be smaller, such as at least 50 or at least 100 objects, although not necessarily so.

The illustrated instructions include a similarity computation component 40, a representation generator 42, a transformation component 44, a first classifier learning component 46, an ensemble learning component 48, and a prediction component 50. These components are best understood in connection with the method described below.

Briefly, the similarity computation component 40 computes a measure of similarity 60 between the source domain and the target domain based on features of the objects in the two domains. The representation generator 42 generates features-based multidimensional representations 62, 64 of the source and target objects, respectively. In the case of documents as objects, for example, the original representations of the source and target domain objects can be bag-of-words (BOW)-based representations. In the case of images, the representations may be based on descriptors derived from features extracted from patches of the image, such as a Fisher vector or a bag-of-visual-words (BOVW) representation.

The transformation component 44 learns a transformation matrix 66 for projecting (sometimes referred to as embedding) each of the representations 62 of a source object in the collection 34 into a different feature space whose features are predicted to discriminate between labels in both domains, which may be analogous to the SCL-based representations described above. The first classifier learning component 46 learns a first classifier 68 on representations 70 of labeled objects in the collection 34, which have been transformed with the matrix 66, and their respective labels. The ensemble learning component 48 iteratively learns a second classifier 72, based on representations 74 of the target objects transformed with the matrix 66 and respective pseudo-labels. In the iterative learning, the prediction component 50 predicts the pseudo-labels for the target objects using a classifier ensemble 80 which includes weights 82 for the first and second classifiers 68, 72. The prediction component can be subsequently used to predict a label 82 for an unlabeled object in the source domain using the learned ensemble 80, based on its representation 64.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

With reference to FIG. 2, a method for domain adaptation of a classifier is shown. The method starts at S100.

At S102, a collection of labeled source domain objects 34 (or feature-based representations thereof) is received/accessed and may be stored temporarily in memory 12.

At S104, a set of unlabeled target domain objects 36 (or feature-based representations thereof) is received and may be stored in memory 12 during processing.

At S106, a measure of similarity 60 may be computed between the source and target domains based on features of the objects in the respective domains, using the similarity computation component 40. If there are initially more than two source domains, the similarity may be computed for each source domain and the source domain with the highest similarity to the target domain may be selected as the source domain.

At S108, if not already generated, a features-based multidimensional original representation 62 of each source object is generated, by the representation generator 42, based on features extracted from the respective source domain object.

At S110, a features-based multidimensional original representation 64 of each target object is generated, by the representation generator 42, based on features extracted from the respective target domain object.

At S112, a co-occurrence-based transformation matrix 66 for projecting each of the source and target object representations 62, 64 into a different feature space is learned, by the transformation component 44. The matrix Q 66 can be learned from the source and target domains, using the structural correspondence learning (SCL) algorithm (Blitzer 2006).

At S114, the matrix Q 66 is used, e.g., by the transformation component 44, to transform each of the source object representations 62 to generate transformed source representations 70 and to transform each of the target object representations 64 to generate transformed target representations 74.

At S116, a first classifier 68 is trained on representations 70 of labeled source objects, which have been transformed with the matrix 66, and their respective labels. This may be performed by the first classifier learning component 46.

At S118, a second classifier 72 is iteratively learned on the representations 64 of the target objects and respective pseudo-labels which are iteratively generated in the iterative process. During the classifier learning, weight vectors wₛ, wₜ for the classifiers 68, 72 are iteratively updated. The similarity score 60 may be used to determine by how much the weights are adapted at each iteration. FIG. 3 describes the iterative learning process in greater detail, which can be performed by the iterative learning component.

At S120, the trained classifier ensemble 80, which includes a weighted combination of the first and second classifiers 68, 72, may be output.

In some embodiments, at S122, the trained classifier ensemble 80 may be used to provide labels 82 for new, unlabeled target domain objects 84, based on their representations 64. The method ends at S124.

In what follows, the following notations are used.

The representations 62 of the objects 34 from the source domain and their respective labels are denoted {(x₁^{s}, y₁^{s}), (x₂^{s}, y₂^{s}), . . . (xₙ^{s}, yₙ^{s}0}, where xᵢ^{s} denotes a representation of a source object and yᵢ^{s} (or simply yᵢ) denotes its label. The labels can be binary, e.g., the labels represent positive and negative sentiments respectively, in the case of documents expressing an opinion. Then, {xᵢ^{s}, yᵢ^{s}∵_{i=1;n}; xᵢ^{s} ∈ [symbol] ^{d}; yᵢ ∈ {+1, −1∵, where [symbol] ^{d} denotes the space of the source object representations and d denotes the dimensionality of each representation xᵢ^{s}. In other embodiments, there may be more than two possible labels yᵢ, for example, labels may have integer values or scalar values. Q represents the transformation 66 (e.g., projection matrix) learned to represent the feature co-occurrence across two domains (e.g., with SCL). Each object 34 from the source domain is then represented as the embedding Qxᵢ^{s} 70 (i.e., the multiplication of matrix Q and vector xᵢ^{s}).

The representations of unlabeled instances 36 from the target domain are denoted {xᵢ^{t}, x₂^{t}, . . . , xₘ^{t}} in which each object from the target domain has a feature-based representation, denoted xᵢ^{t}, which has the same dimensionality as the source representations xᵢ^{s}. Transformed target representations 74 are then Qxᵢ^{t}. The target domain data is divided into two pools, Pᵤ and Pₛ, which represent a pool of unlabeled and pseudo-labeled objects, respectively. Initially, all target domain objects are in the unlabeled pool Pᵤ, as no labeled data is available from the target domain (if a small amount of labeled data is available, it could be placed in Pₛ). The pseudo-labels for the target objects are denoted ŷᵢ^{t} (or simply ŷᵢ). The two classifiers are trained on the two views of the target data. The first classifier 68, denoted Cₛ, is trained on the shared co-occurrence-based representations Qxᵢ^{s} and their respective labels yᵢ^{s} and the second classifier 72, denoted Cₜ is trained on the target object representations xᵢ^{t} (not transformed with Q), and respective pseudo-labels ŷᵢ^{t}, where ŷᵢ^{t} is the pseudo-label predicted by Ensemble E. In the example embodiment, each classifier Cₛ, Cₜ is a function from [symbol] ^{d}→{−1, +1}, where [symbol] ^{d} is the space real numbered representations of dimension d, and the function outputs a label in the range −1 to +1, in an example embodiment. W^{s}, w^{t} denote the weights for classifiers Cₛ and Cₜ, respectively, in the ensemble 80.

Input objects (S102, S104)

Example objects 34, 36 which can be used by the system include text documents and images. In the case of a “text document,” the term is used herein to mean an electronic (e.g., digital) recording of information which includes a sequence of characters drawn from an alphabet, such as letters, numbers, etc. The character sequence typically forms words in a natural language, although biological sequences, computer code, and the like are also contemplated. Documents can be received by the system in any suitable form, such as Word documents, scanned and OCR-ed PDFs, and the like.

An “image,” as used herein includes an array of pixels. Images may be received by the system in any convenient file format, such as JPEG, GIF, JBIG, BMP, TIFF, or the like or other common file format used for images and which may optionally be converted to another suitable format prior to processing. The images may be individual images, such as photographs, video images, or combined images which include photographs along with text, and/or graphics, or the like. In general, each input digital image includes image data for an array of pixels forming the image. The image data may include colorant values, such as grayscale values, for each of a set of color separations, such as L*a*b* or RGB, or be expressed in another color space in which different colors can be represented. In general, “grayscale” refers to the optical density value of any single color channel, however expressed (L*a*b*, RGB, YCbCr, etc.). The exemplary embodiment is suited to both black and white (monochrome) and color images.

The documents or images can be input from any suitable image source, such as a workstation, database, memory storage device, such as a disk, or the like.

### Original Representations (S108, S110)

The representations xᵢ^{t} and xᵢ^{s} generated by the representation generator 42 for each input source and target object can be any suitable high level statistical representation of the object.

In the case of an image, for example the representation may be a multidimensional vector generated based on features extracted from the image. Fisher Kernel representations and Bag-of-Visual-Word representations are exemplary of suitable high-level statistical representations which can be used herein. The exemplary representations xᵢ^{t} and xᵢ^{s} are of a fixed dimensionality d, i.e., each representation has the same number of elements. For example, the representation generator 42 includes a patch extractor, which extracts and analyzes low level visual features of patches of the image, such as shape, texture, or color features, or the like. The patches can be obtained by image segmentation, by applying specific interest point detectors, by considering a regular grid, or simply by the random sampling of image patches. In the exemplary embodiment, the patches are extracted on a regular grid, optionally at multiple scales, over the entire image, or at least a part or a majority of the image. Each patch includes a plurality of pixels and may include, for example, at least 16 or at least 64 or at least 100 pixels. There may be at least 16 or at least 32 patches extracted from each image. Low level features (in the form of a local descriptor, such as a vector or histogram) are extracted from each patch. These can be concatenated and optionally reduced in dimensionality, to form a features vector which serves as the global image signature. In other approaches, the local descriptors of the patches of an image are assigned to clusters. For example, a visual vocabulary is previously obtained by clustering local descriptors extracted from training images, using for instance K-means clustering analysis. Each patch vector is then assigned to a nearest cluster and a histogram of the assignments can be generated. In other approaches, a probabilistic framework is employed. For example, it is assumed that there exists an underlying generative model, such as a Gaussian Mixture Model (GMM), from which all the local descriptors are emitted, as in the case of a Fisher Vector or BOVW representation. The patches can thus be characterized by a vector of weights, e.g., one weight per parameter considered for each of the Gaussian functions forming the mixture model. In this case, the visual vocabulary can be estimated using the Expectation-Maximization (EM) algorithm. In either case, each visual word in the vocabulary corresponds to a grouping of typical low-level features. Given an image to be assigned a representation xᵢ^{t} or xᵢ^{s}, each extracted local descriptor is assigned to its closest visual word in the previously trained vocabulary or to all visual words in a probabilistic manner in the case of a stochastic model. A histogram is computed by accumulating the occurrences of each visual word. The histogram can serve as the representation or input to a generative model which outputs an image signature based thereon. Methods for computing Fisher vectors are more fully described in U.S. Pub. Nos. 20120076401, 20120045134; the BOVW method is described in U.S. Pub. No. 20080069456, the disclosures of which are incorporated herein by reference.

Documents can be represented by a Bag-of-Words BOW representation. For example, a set of words is selected and for each document, a histogram of word frequencies is generated. A transformation, such as a term frequency-inverse document frequency (TF-IDF) transformation, may be applied to the word frequencies to reduce the impact of words which appear in all/many documents. Normalization, e.g., L2 normalization may be performed to generate feature values for the representation. In some embodiments, features can be based on sequences of words and/or sequences of parts of speech.

As will be appreciated, once the representations xᵢ^{s} have been computed, they need not be recomputed for new domains.

Generation of transformation matrix (S112)

As noted above, as in the method of Blitzer 2006, SCL is used to identify correspondences among features from different domains by modeling their correlations with pivot features. Pivot features are features which behave in the same way for discriminative learning in both domains and typically occur frequently in both domains. Pivot features can be identified with binary classifiers, such as “is word x present?” or “is the token x followed by/preceded by token y”. SCL models the correlation between the pivot features and all other features by training linear predictors to predict the presence of pivot features in unlabeled data. Non-pivot features from different domains which are correlated with many of the same pivot features are assumed to correspond, and are treated similarly in a discriminative learner.

Each pivot predictor is characterized by a weight vector which encodes the covariance of the non-pivot features with each of the pivot features. If feature z is positively correlated with pivot feature 1, the weight given to the z′th feature by the l′th pivot predictor is positive. The weight vector is a linear projection of the original feature space onto a new feature space. The pivot predictors are combined to form a matrix W, which represents the principal predictors for the weight space. The top k=50 Eigenvectors of the matrix W are selected to form matrix Q. These principal predictors efficiently discriminate among positive and negative words in both domains. The features in the original representations are projected into the new feature space by multiplying the feature vectors with matrix Q to obtain the shared co-occurrence based representation.

Classifier learning (S116, S210)

Any suitable training method may be employed for learning the parameters of the classifiers Cₛ and Cₜ, such as Sparse Linear Regression (SLR), Sparse Multinomial Logistic Regression (e.g., for a classifier which classifies into more than two classes), standard logistic regression, support vector machine (SVM), neural networks, linear discriminant analysis, support vector machines, naive Bayes, or the like. See, e.g., B. Krishnapuram, L. Garin, M. Figueiredo, and A. Hartemink, “Sparse multinomial logistic regression: Fast algorithms and generalization bounds,” IEEE PAMI, 27(6):957-968 (2005).

Computing Domain similarity (S106)

The domain similarity 60 determines how much knowledge to transfer by seamlessly incorporating similarity of domains in the domain adaptation method. In the exemplary method, where the objects are text documents, the similarity between the two domains may be measured in terms of the cosine similarity of the textual context (e.g., using feature vectors, where each feature vector represents the frequency of each of a set of words in a respective collections of documents drawn from the respective domain). However, the exemplary method is general in nature and can include similarity computed based on other measures depending on the content.

Iterative learning process (S118)

The aim is to learn two classifiers, one based on SCL-based transformed representations and other on BOW or other original representations of iteratively increasing pseudo-labeled data from the target domain. Predictions of these two classifiers are combined in an ensemble as a weighted combination in proportion to the similarity of source and target domain data. In each iteration, this ensemble is then used to predict labels for the remaining unlabeled target domain instances. Confidently predicted instances in an iteration are used to re-train target specific classifier and update the ensemble weights. This process is performed until all unlabeled instances are confidently predicted or a predefined maximum number of iterations is exhausted, such as (at least) 5, 10, 50 or 100, iterations, or more.

The knowledge transfer occurs in an iterative manner at two stages: 1) within the ensemble where a classifier trained on the shared transformed representation facilitates to learn the domain-specific classifier and 2) the weights for the individual classifiers are updated after each iteration which progressively assigns more weight to the target specific classifier in proportion to the similarity between the two domains.

With reference now to FIG. 3, an iterative process for learning the second classifier and classifier weights (S118) is shown.

Step S118 takes as input the classifier Cₛ which has been learned at S116 on transformed source representations and their respective labels {Qxᵢ^{s}, yᵢ^{s}}. Since Cₛ is learned only on the transformed (SCL) source representations, it does not learn the significance of domain-specific features that are highly discriminative in the target domain.

At S202, labels for for the target domain instances in the pool Pᵤ are predicted with the first classifier Cₛ, using the transformed target representations Qxᵢ^{t} generated at S114. This step may be performed using the prediction component 50.

At S204, target instances xᵢ^{t} whose labels yl are predicted by Cₛ with a confidence greater than a first θ₁ are identified. For example, if the classifier predicts a binary label with values in the range 0 to 1, 1 being the most confident an 0 being the least, and the threshold θ₁ is set at 0.8, then all target instances for which the label is predicted with a value of greater than 0.8 are identified.

At S206 the target instances xᵢ^{t} identified at S204 are removed from Pᵤ and added to Pₛ with their pseudo label ŷᵢ^{t} predicted by Cₛ. Those target instances whose label is not predicted with a confidence above the threshold θ₁ remain in Pᵤ (S208).

At S210, the second classifier Cₜ is learned on target domain instances and their respective pseudo-labels that ate currently in the pool Pₛ E∈ {xᵢ^{t}, ŷᵢ^{t}}, in order to incorporate target specific features. Specifically, Cₜ is learned on the original representations xᵢ^{t}, rather than on the transformed representations Qxᵢ^{t}.

Pₛ initially contains only a small set of instances added in S206 but grows iteratively as instances are added from Pᵤ. At S212, the classifiers Cₛ and Cₜ are aggregated in an ensemble E 80, as a weighted combination of Cₛ and Cₜ with respective weights w^{s} and w^{t}, where w^{s}+w^{t}=1. For the first iteration, w^{s} and w^{t} may both be initialized with the same value (0.5) or other suitable weights. To regulate knowledge transfer, the similarity between the two domains computed at S106 may be incorporated in the weights associated with the individual classifiers, as shown in Eqs. 2 and 3, below.

At S214, the classifier ensemble E is applied to all the target representations remaining in the pool Pᵤ (i.e., to all xᵢ^{t} ∈ Pᵤ) to to obtain predicted labels ŷᵢ^{t} as:

E(xᵢ^{t})→ŷᵢ^{t}→w^{s}Cₛ(Qxᵢ^{t})+w^{t}Cₜ(xᵢ^{t}) (1)

i.e., the label ŷᵢ^{t} is a weighted combination of the output of the first classifier Cₛ, given the transformed target representation Qxᵢ^{t}, and the output of the second classifier Cₜ, given the untransformed target representation xᵢ^{t}.

If at S216, the ensemble classifies the instance xᵢ^{t} with a confidence greater than a second threshold θ₂, then the method returns to S206, where that instance xᵢ^{t} is removed from pool Pᵤ and added to the pool Pₛ of pseudo-labeled instances, along with its pseudo-label ŷᵢ^{t}. Otherwise, the method proceeds to S218. The second threshold θ₂ may be the same as the first threshold θ₁ or may be different. The threshold θ₂may be fixed or may vary, for example, it may increase or decrease with each iteration.

In some embodiments, the method waits until all instances left in the pool for that iteration have been processed using the same ensemble E, then the method proceeds to S210, where the classifier is retrained Cₜ and the ensemble is re-constructed at S212 using the retrained classifier and the updated weights. In other embodiments, the method proceeds from S206 to S210 and S212 for each new pseudo-labeled instance xᵢ^{t} that is added to the pool Pₛ at S206. Specifically, at S210, classifier Cₜ is re-trained on the current pool Pₛ of pseudo-labeled instances and the ensemble is regenerated at S212 using current weights.

If at S218, there are remaining xi in Pᵤ, steps S214 and S216 are repeated, until all xᵢ^{t} in Pᵤ have been processed. Otherwise, the method proceeds to S220.

If at S220, there are no more objects xᵢ^{t} in Pᵤ (or a predetermined number of iterations has been performed) the method proceeds to S118 (FIG. 2).

Otherwise, at S222, the weights w^{s} and w^{t} are updated. In one embodiment, the updating is a function of the similarity between the domains (computed at S106). For example, weights w^{s} and w^{t} are updated as:

$$\begin{matrix}{w}_{( l + 1 )}^{s} = \frac{( sim * {w}_{l}^{s} * I ( {C}_{s} ) )}{( sim * {w}_{l}^{s} * I ( {C}_{s} ) + ( 1 - sim ) * {w}_{l}^{t} * I ( {C}_{t} ) )} & ( 1 ) \\ {w}_{( l + 1 )}^{t} = \frac{( ( 1 - sim ) * {w}_{l}^{t} * I ( {C}_{t} ) )}{( sim * {w}_{l}^{s} * I ( {C}_{s} ) + ( 1 - sim ) * {w}_{l}^{t} * I ( {C}_{t} ) )} & ( 2 )\end{matrix}$$

where, l is the iteration, sim is the similarity score between the two domains, and l(·) is a loss function which incorporates a learning rate. For example, an exponential loss function of the form:

I(·)=exp{ηl(y, ŷ)} (3)

is employed, where, η is the learning rate, which can be fixed or variable and l(y, ŷ) is a loss term. For example, 0<η<0.3, e.g., is set to 0.1, and l(y, ŷ)=(y−ŷ)² is a square loss function, where y is the label predicted by the classifierCₜ and ŷ is the label predicted by the ensemble.

In another embodiment, the similarity measure is not employed in updating the weights. In Eqns 2 and 3, it can be assumed to be 1 for the source weight and 0 for the target weight, e.g.:

$$\begin{matrix}{w}_{( l + 1 )}^{s} = \frac{( {w}_{l}^{s} * I ( {C}_{s} ) )}{( {w}_{l}^{s} * I ( {C}_{s} ) + {w}_{l}^{t} * I ( {C}_{t} ) )} & ( 5 ) \\ {w}_{( l + 1 )}^{t} = \frac{( {w}_{l}^{t} * I ( {C}_{t} ) )}{( {w}_{l}^{s} * I ( {C}_{s} ) + {w}_{l}^{t} * I ( {C}_{t} ) )} & ( 6 )\end{matrix}$$

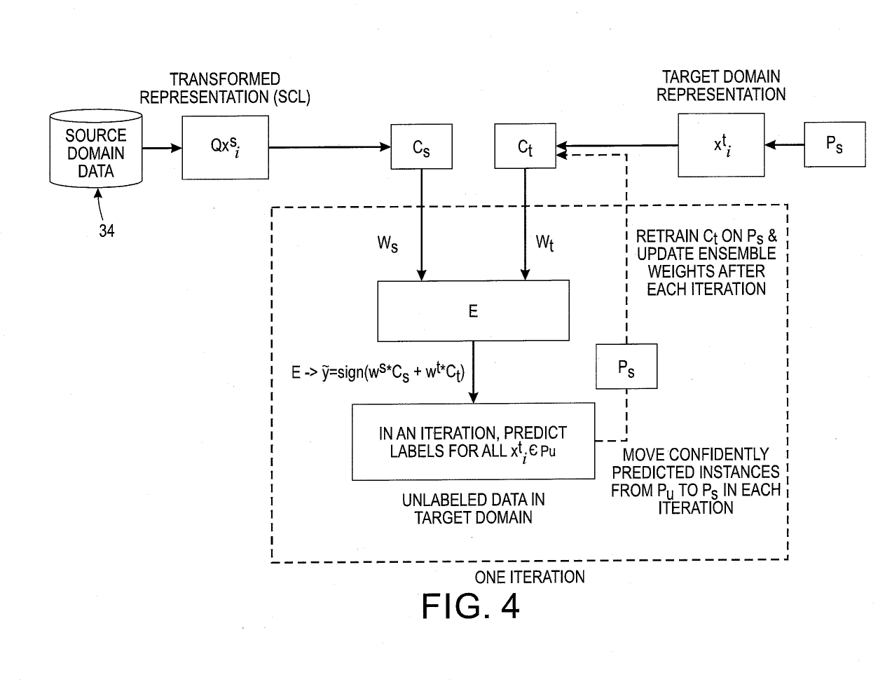

In an iterative manner, the exemplary method transforms the unlabeled data in the test domain into pseudo-labeled data and progressively learns the classifier Cₜ on the original feature representations xᵢ^{t} to adapt to the target domain. The weights for the two classifiers are also updated at the end of each iteration, which gradually shifts the emphasis from the classifier Cₛ learned on the shared co-occurrence based representation to the classifier Cₜ learned on domain-specific features. At the end of the iterative learning process, the weighted ensemble 80 is now ready for use to classify unseen instances from the target domain. Algorithm 1 illustrates step S116 in accordance with one embodiment, which is illustrated in the flow chart shown in FIG. 4.

Algorithm 1 Content-aware domain adaptation

Input: Cₛ trained on shared co-occurrence based representation Qxᵢ^{s} , Cₜ
initiated on BOW representation from Pₛ, Pᵤ unlabeled target domain
training instances.
Iterate: = 0 : till Pᵤ = {Ø}
Process: Construct ensemble E as weighted combination of Cₛ and Cₜ with
initial weights wₗ^{s} and wₗ^{t} as 0.5 and sim = similarity between two
domains.
for i = 1 to n (size of Pᵤ) do

Predict labels: E(Qxᵢ^{s} ,xᵢ^{s}) → ŷᵢ; calculate αᵢ : confidence of
prediction
if αᵢ > θ then

Remove ith instance from Pᵤ and add to Pₛ.

end if.

end for.
Retrain Cₜ on Pₛ. and update wₗ^{s} and wₗ^{t}
end iterate.
Output: Updated classifier Cₜ and current weights w^{s} and w^{t}

The method illustrated in FIG. 2 and/or FIGS. 3 and 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive of independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 2-4, can be used to implement the adaptation method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Without intending to limit the scope of the exemplary embodiment, the following examples demonstrate the applicability of the method.

### EXAMPLES

In the following, the exemplary content-aware domain adaptation method is compared to other classification methods in the context of sentiment analysis.

Sentiment analysis of user-generated data from the web has generated a wide interest from both academia as well as industry. The amount of data available on the web in the form of reviews and short text offers the potential for businesses to analyze public opinion about their products and services and to gain actionable business insights. Customers are able to express their opinions about a wide variety of topics in different domains, such as movies, news articles, finance, telecommunications, healthcare, automobile, as well as other products and services. The exemplary content-aware domain adaptation technique is particularly useful for cross-domain sentiment categorization problems. A two-class sentiment classification problem that aims at classifying text into positive and negative categories is considered.

To evaluate the efficacy of the exemplary approach, experiments are performed on the publicly available Amazon review dataset (see, Blitzer 2007) which has four different domains, namely, books (Domain B), DVDs (Domain D), kitchen appliances (Domain K) and electronics (Domain E). In the experimental evaluation, equal numbers of positive and negative reviews are considered from the balanced data set, where each domain includes 1000 positive and 1000 negative reviews. In all experiments, 1600 reviews are used for training and the performance is reported on non-overlapping 400 reviews.

Table 1 lists the similarity scores computed between the four domains from the Amazon reviews database using cosine similarity.

TABLE 1
Similarity scores computed across four domains

| | Books | DVDs | Electronics | Kitchen |
|---|---|---|---|---|
| Books | 1.0 | 0.29 | 0.52 | 0.54 |
| DVDs | 0.29 | 1.0 | 0.33 | 0.34 |
| Electronics | 0.52 | 0.33 | 1.0 | 0.78 |
| Kitchen | 0.54 | 0.34 | 0.78 | 1.0 |

In the experiments, the constituent classifiers in the ensemble are both SVMs with an RBF kernel. Labeled data from the source domain and unlabeled data from the target domain is utilized for training and the final performance is reported on unseen target domain data. The performance of the method on a cross-domain sentiment categorization task is compared with different techniques, as follows:

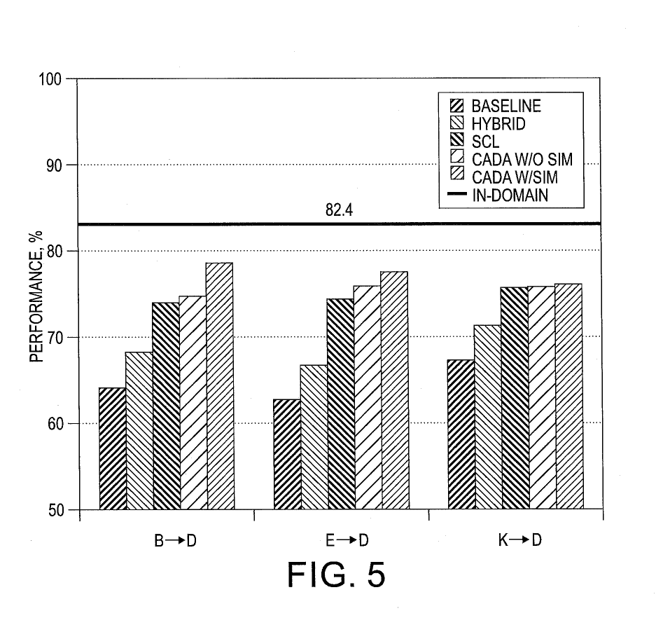

1. In-domain classifier: this method does not assume any domain shift. The classifier is trained on 1600 labeled instances and the performance is reported on 400 non-overlapping instances from the same domain, i.e., supervised learning settings. The horizontal line on each bar plot in FIGS. 5 shows the in-domain performance.

2. Baseline: The baseline approach trains the classifier on the 1600 labeled instances from the source domain and tests the performance on 400 instances from the target domain.

3. Structural correspondence learning (SCL): as described above, this is approach is widely used for cross-domain sentiment analysis.

4. Content Aware Domain Adaptation without similarity (CADA w/o sim): The exemplary method, but without using the similarity measure to update the weights.

Content Aware Domain Adaptation with similarity measure for updating the weights (CADA w/sim): The exemplary method, using the similarity measure to update the weights.

In the present method, the classifier Cₛ is learned on the SCL representation, hence does not learn the significance of domain-specific features that are highly discriminative in the target domain. Classifier Cₜ is initially trained on just a handful of pseudo-labeled instances and at this stage, may have not learned a good decision boundary. The classifiers are individually not sufficient to perform well on the target domain instances; however, if combined they yield better performance for classifying the target domain instances, as shown in TABLE 3.

TABLE 3
Comparison of the performance of individual classifiers v/s when
they are combined in ensemble for training on the Books domain and
testing across different domains. Cₛ and Cₜ are applied on the
test domain data before performing the iterating learning process

| | Cₛ | Cₜ | Ensemble |
|---|---|---|---|
| B → D | 63.1 | 34.8 | 72.1 |
| B → E | 64.5 | 39.1 | 75.8 |
| B → K | 68.4 | 42.3 | 76.2 |

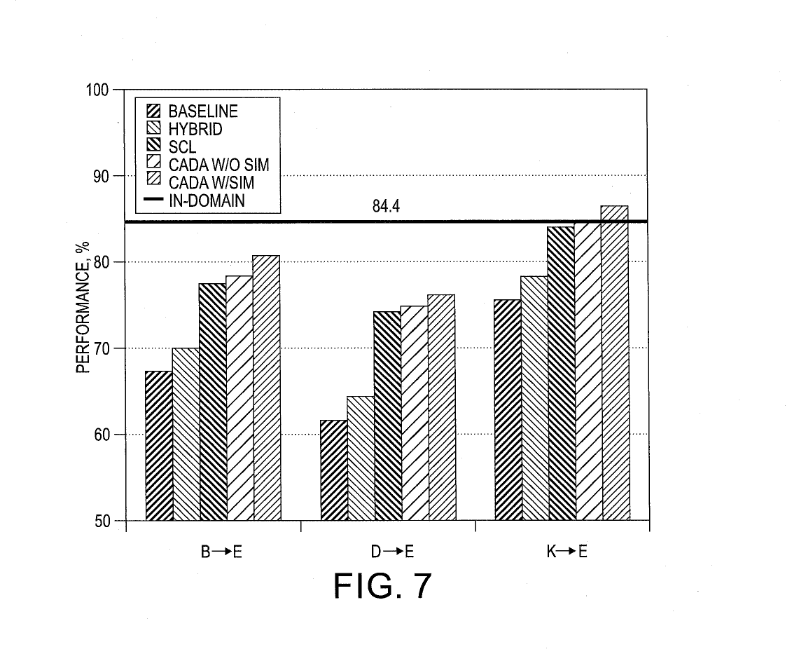

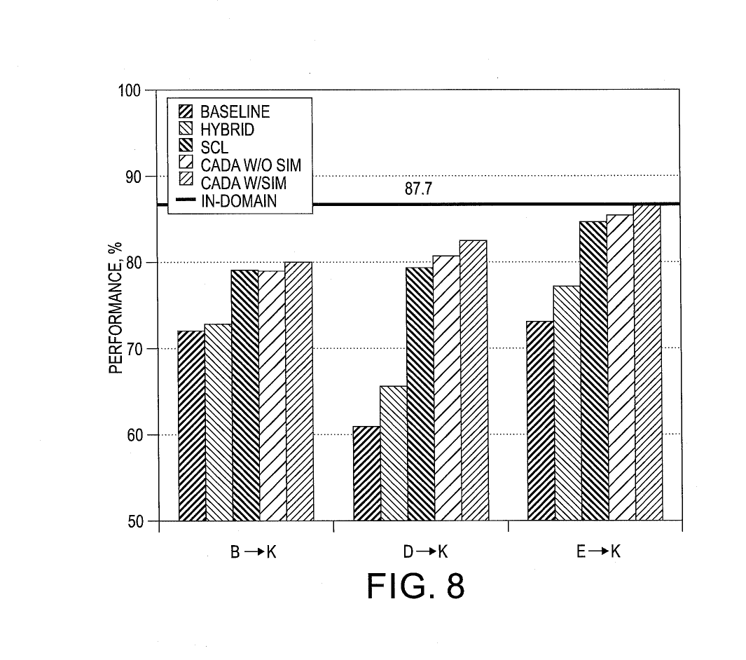

The results in FIGS. 5-8 show the performance of the exemplary method for cross-domain sentiment categorization. The in-domain approach can be considered as the gold standard as it makes use of in-domain labeled training data. The exemplary method is generally closest to the in-domain performance as compared to existing approaches as it leverages the target specific features along with the shared co-occurrence based feature representation across two domains. It outperforms existing approaches which rely only on shared co-occurrence based feature representation.

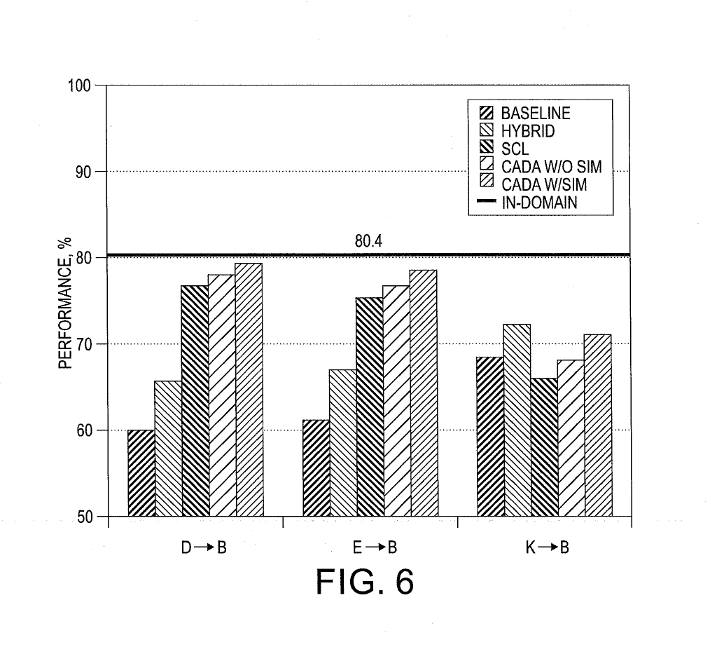

As an example, the results shown in FIG. 6 for two dissimilar domains (e.g., for the case K B) illustrate the performance gain achieved by incorporating domain similarity to regulate knowledge transfer. Since the SCL based approach does not incorporate similarity between the domains, it suffers from the effects of negative transfer, which lead to a performance that is even lower than the baseline approach. However, the exemplary method is able to sustain its performance by regulating knowledge transfer in proportion to the similarity between the domains, thus mitigating the impact of negative transfer.

The exemplary method enhances the performance of cross-domain sentiment categorization task at two stages: 1) by learning the target domain-specific features from unlabeled target domain data, and 2) by regulating the amount of knowledge transfer based on the similarity of two domains. The benefits of using both of these individual stages demonstrated in FIGS. 5-8 for incorporating target domain-specific features and similarity between domains in adaptation settings for enhanced cross-domain classification performance is clearly evident.

The exemplary method facilities the knowledge transfer within an ensemble where the classifier trained on the shared co-occurrence based representation transfers its knowledge to the target specific classifier by providing pseudo-labels to train the target specific classifier. The weights for these two classifiers represent the contributions of the individual classifiers for categorizing the target domain instances. In the experiments, it was observed that, at the end of iterative learning process, the target-specific classifier is assigned more weight, as compared to the classifier trained on the shared representation. On average, the weights for the two classifiers converge at w^{s}=0.21 and w^{t}=0.79. This provides further evidence that target-specific features are more discriminative than the shared co-occurrence based features in classifying target domain instances. However, combining both these features in a weighted manner within an ensemble yields better cross-domain classification performance.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. An adaptation method comprising:
providing a first classifier trained on projected representations of objects from a first domain and respective labels, the projected representations having been generated by projecting original representations of the objects in the first domain into a shared feature space with a learned transformation;
providing a pool of original representations of unlabeled objects in a second domain;
projecting the original representations of the unlabeled objects with the learned transformation;
predicting pseudo-labels for ‘the projected representations of the unlabeled objects with the first classifier, each of the predicted pseudo-labels being associated with a confidence;
iteratively learning a classifier ensemble comprising a weighted combination of the first classifier and a second classifier, the learning including:
training the second classifier on the original representations of the unlabeled objects for which the confidence for respective pseudo-labels exceeds a threshold;
constructing a classifier ensemble as a weighted combination of the first classifier and the second classifier;
predicting pseudo-labels for remaining unlabeled objects with the classifier ensemble based on their original representations;
adjusting weights of the first and second classifiers in the classifier ensemble as a function of a learning rate; and
repeating the training, constructing, predicting, and adjusting;
wherein at least one of the predicting of pseudo-labels and iteratively learning the classifier ensemble is performed with a processor.

2. The method of claim 1, wherein the shared representation is based on co-occurrence statistics.

3. The method of claim 1, wherein the objects in the first and second domains are text documents and the original representations are based on word frequencies in the text documents.

4. The method of claim 1, wherein the learned transformation is a matrix.

5. The method of claim 1, wherein the weights of the first and second classifiers in the classifier ensemble are also adjusted as a function of a measure of similarity between the first and second domains.

6. The method of claim 5, wherein the measure of similarity is a cosine similarity between feature-based representations of documents in the first and second domains.

7. The method of claim 1, wherein the predicting pseudo-labels for the original representations of the unlabeled objects with the classifier ensemble comprises weighting a prediction of the first classifier with a first weight and weighting a prediction of the second classifier with a second weight and summing the weighted predictions.

8. The method of claim 1, wherein the iterative leaning includes, for a first iteration, initializing the weights of the first and second classifiers.

9. The method of claim 1, wherein the repeating of the training, constructing, predicting, and adjusting is performed until all of the unlabeled objects in the second domain have been assigned a label with at least a threshold confidence or until a predetermined number of iterations has been performed.

10. The method of claim 1, further comprising outputting the second classifier and the learned weights.

11. The method of claim 1, further comprising using the learned classifier ensemble to predict a label for a new unlabeled object in the second domain, based on its original representation.

12. The method of claim 1, wherein in a subsequent iteration, the training of the second classifier is performed with the original representations of the unlabeled objects for which a confidence for the respective pseudo-labels predicted in a prior iteration exceeds a second threshold which is different from the threshold used for pseudo-labels predicted for the projected representations of the unlabeled objects with the first classifier.

13. The method of claim 1 wherein the labels are opinion-related labels.

14. The method of claim 1, further comprising learning the transformation with structural correspondence learning based on features extracted from objects in the first and second domains.

15. A computer program product comprising a non-transitory recording medium storing instructions, which when executed on a computer, causes the computer to perform the method of claim 1.

16. A system comprising memory which stores instructions for performing the method of claim 1 and a processor in communication with the memory for executing the instructions.

17. A system for predicting labels for unlabeled objects in the second domain comprising:
memory which stores:
a classifier ensemble learned by the method of claim 1;
a prediction component for predicting the label of an unlabeled objects in the second domain with the learned classifier ensemble; and
a processor which implements the prediction component.

18. An adaptation system comprising:
memory which stores:
a learned transformation;
a first classifier that has been trained on projected representations of objects from a first domain and respective labels, the projected representations having been generated by projecting original representations of the objects in the first domain with the learned transformation;
optionally, a representation generator which generates original representations of unlabeled objects in a second domain;
a transformation component which projects the original representations of the unlabeled objects with the learned transformation;
a prediction component which predicts pseudo-labels for unlabeled objects in a second domain with the first classifier based on the projected representations of the unlabeled objects;
an ensemble learning component which iteratively learns a classifier ensemble comprising a weighted combination of the first classifier and a second classifier, the learning including:
training the second classifier on the original representations of the unlabeled objects for which a confidence for the respective pseudo-labels exceeds a threshold confidence;
constructing a classifier ensemble as a weighted combination of the first classifier and the second classifier;
predicting pseudo-labels for remaining unlabeled objects with the classifier ensemble based on their original representations;
adjusting weights of the first and second classifiers in the classifier ensemble as a function of a learning rate; and
repeating the training, constructing, predicting, and adjusting; and
a processor which implements the transformation component, prediction component, and ensemble learning component.

19. The system of claim 18 further comprising a similarity component which computes a similarity between the first and second domains, the ensemble learning component adjusting the weights of the first and second classifiers in the classifier ensemble as a function of the computed similarity.

20. An adaptation method comprising:
learning a transformation based on features extracted from objects in first and second domains;
computing a similarity between the first and second domains;
projecting original representations of labeled objects in the first domain and unlabeled objects in the second domain with the learned projection;
training a first classifier on the projected representations of the objects from the first domain and respective labels;
predicting pseudo-labels for the projected representations of the unlabeled objects with the first classifier;
iteratively learning a classifier ensemble comprising a weighted combination of the first classifier and a second classifier, the learning including:
training the second classifier on the original representations of those of the unlabeled objects and respective pseudo-labels for which a confidence for the respective pseudo-labels exceeds a threshold confidence;
constructing a classifier ensemble as a weighted combination of the first classifier and the second classifier;
predicting pseudo-labels for the original representations of remaining unlabeled objects with the classifier ensemble;
adjusting weights of the first and second classifiers in the classifier ensemble as a function of the computed similarity; and
repeating the training, constructing, predicting, and adjusting,
wherein at least one of the learning of the transformation, computing of the similarity, projecting of the original representations, training of the first classifier, predicting of the pseudo-labels, and iteratively learning the classifier ensemble is performed with a processor.
